(19) United States
(12) Patent Application Publication
(10) Pub. No.: US 2021/0293451 A1
(43) Pub. Date: Sep. 23, 2021

(54) System and Method for Storage of Renewable Energy as Hot or Cold Water in Flexible Heating Tanks

(71) Applicant: EZ PACK WATER LTD, Savion (IL)

(72) Inventors: Alex Harel, Savion (IL); Ohad Zecharia, Shomrat Kibuts (IL); Shalom Green, Haifa (IL)

(21) Appl. No.: 17/266,116

(22) PCT Filed: Aug. 3, 2019
(86) PCT No.: PCT/IL2019/050879

§ 371 Date: Feb. 5, 2021

(30) Foreign Application Priority Data
Aug. 10, 2018 (IL) 261096

(51) Int. Cl. F24H 1/18; F24H 1/06; F24H 9/18; F24H 9/20; F24D 17/00

(52) U.S. Cl. CPC F24H 1/181; F24H 1/06; F24H 1/185; F24H 9/1818; F24D 2200/15; F24D 17/0036; F24D 17/0015; F24D 2200/02; F24D 2200/14; F24H 9/2021

(57) ABSTRACT

A system for hot and cold water supply to consumers that includes photovoltaic solar panel, wind turbine, water heating tank, water tank and cooling system. The heating tank includes an electrical connection mechanism, an outer layer, a water bag and heating carpet that is positioned in a dry space between them. The water tank includes an outer layer and a water bag. The electrical connection mechanism connects the heating carpet and the cooling system to the photovoltaic solar panel and to the wind turbine. The volume of the heating tank or the water tank are larger than the volume of the average hourly hot or cold water consumption of the consumer. The system is able to supply hot and cold water also at times that the photovoltaic solar panel and the wind turbine do not produce electricity.

### TECHNICAL FIELD

The present invention refers to a method and a system for “Off-Grid” storage of renewable energy, sunlight and wind, as hot water in flexible heating tanks or as cold water in flexible thanks and supplying the hot or cold water to consumers according to demand in relevant times.

### BACKGROUND ART

In many cases there is a need to supply hot or cold water. It is understood that the best is to use renewable energy, sunlight and wind, as sources of energy for supplying hot or cold water. However, there is a need for such hot or cold water also in times when there is no sunlight or wind or when the power supply from the renewable energy sources is less than the power required to heat or cool the water at times of increased consumption. The known answer for such problem is to store the electrical energy which is produced when employing the renewable energy in batteries. But, the process of storage and the batteries themselves are relatively very expensive. The present invention provides efficient and cost effective solution for this problem by heating or cooling a water body that is stored in a flexible bladder.

### DESCRIPTION OF THE DRAWINGS

The intention of the drawings attached to the application is not to limit the scope of the invention and its application. The drawings are intended only to illustrate the invention and they constitute only one of its many possible implementations.

FIG. 1 presents schematically the system (9) for supplying hot water to consumer (95) that incudes photovoltaic solar panel (91), wind turbine (92), and several flexible water heating tanks (2).

FIG. 2 presents schematically the system (9) for supplying cold water to consumer (95) that incudes photovoltaic solar panel (91), wind turbine (92), cooling system (93) and several flexible water tanks (94).

FIG. 3 presents schematically the flexible water heating tank (2), the water inlet hose (51), the water outlet hose (52), the electrical connection mechanism (32), and the controller (33).

FIG. 4 presents schematically the water bag (22) and its water inlet hose (51).

FIG. 5 presents schematically the flexible water heating tank (2) with the flexible heating carpet (3).

FIG. 6 presents schematically the flexible heating carpet (3) with the flexible electrical heating strips (31).

### THE INVENTION

We will start with some known information as to the general state of art that is connected to the present invention. Photovoltaic solar panels are used for producing electricity (DC output) at times of sunlight. Another source of renewable energy is the wind. A wind turbine is a device that converts the wind's kinetic energy into electrical energy (AC that can be converted to DC). Wind turbines are manufactured in a wide range of vertical and horizontal axis and at the present there are small turbines that can be used even for domestic applications. A standard wind turbine includes the rotor, the blades for converting wind energy to low speed rotational energy, the generator, control electronics and usually a gear box.

The object of the present invention is to provide a method and a system (9) for producing electricity by a photovoltaic solar panel (91) and/or wind turbine (92), at times of sunlight and/or wind. The electricity is used directly to heat water inside a flexible water heating tank (2) or to cool water by a cooling system (93) and storing the cold water in a flexible water tank (94). Then, it is possible to supply the hot water or the cold water to hot or cold water consumer (95) at the times of needs even in times that the photovoltaic solar panel (91) and the wind turbine (92) do not produce electricity or when the power supply from the photovoltaic solar panel (91) and/or wind turbine (92) is less than the power required to heat or cool amount volume of water needed at times of increased consumption.

The photovoltaic solar panel (91) and the wind turbine (92), their components and the way they work are known to ordinary experts in the field and there is no need to describe them in details. The cooling system (93) too is within the common knowledge of ordinary experts and it can be for example any kind of refrigerator that employed electricity to cool water.

The consumer (95) may be for example a residential building that needs hot water supply for domestic needs, a factory and the like. The consumer (95) may be also for example a dairy farm that needs cold water for cooling the raw materials and the dairy products. We use these two examples in this application as examples only without limiting the kinds and types of the possible consumers (95).

The fact that there is no need to storage the electricity produced from the renewable energy as electrical energy in batteries, but as hot or cold water for supply and use at times of needs improves the abilities of employing these renewable energy sources and to make it efficient. For achieving this efficiency the volume of the flexible water heating tank (2) should be larger than the volume of the average hourly hot water consumption of the specific consumer (95). The same is true for cold water consumption. For the sake of fluency we will relates to hot water supply and the details are apply, mutatis mutandis, to cold water.

Usually, the volume of a standard heating tank for a private house is about 120 litters and the water temperature is about 85 degrees Celsius. Thus, relatively small amount of very hot water can serve for such private house. The implementation of the present invention for a private house should be done by using a flexible water heating tank (2) at a volume of about 400 litters and when the temperature of the water in it is about 35 to 45 degrees Celsius can provide the need, means, larger amount of water with less hot temperature.

Based on the same principle of the previous paragraph, for example, the specific system (9) for supplying hot water to a specific consumer (95) of a residential building type that consume about 200 liters of hot water per hour in average should include a flexible water heating tank (2) of a volume of 6000 to 8000 liters greater. During times of sunlight the photovoltaic solar panel (91) produce electricity that heat the water in the flexible water heating tank (2) and during times of wind the wind turbine (92) do the same. The fact that the volume of the hot water are substantially greater than the average hourly consumption make it possible to storage the energy for future use even when the water are at a temperature of about 35 to 45 degrees Celsius.

The flexible water heating tank (2) includes a flexible heating carpet (3) and an electrical connection mechanism (32). The flexible water heating tank (2) comprises a flexible outer layer (21) and separable inflatable and collapsible water bag (22). The flexible water heating tank (2) may also include an insulating layer (23). The separable inflatable and collapsible water bag (22) is equipped with a water inlet hose (51) and a water outlet hose (52). The water bag (22) is designed to receive water through the water inlet hose (51) and to supply water through the water outlet hose (52). The water bag (22) is positioned inside the flexible outer layer (21) and is designed to remain collapsed when empty of water. The water inlet hose (51) and the water outlet hose (52) are accessible through an opening (55) in the flexible outer layer (21). The water bag (22) can be replaced by a new one in maintenance.

The water bag (22) is designed to inflate when filled with water while positioned in the flexible outer layer (21) and to deflate when the water is drained from the water bag (22). In the same way, the flexible outer layer (21) is designed to inflate when the water bag is filled with water while positioned inside the flexible outer layer (21) and to deflate when the water is drained from the water bag (22).

A dry space (7), like a gap even very small, is defined between the flexible outer layer (21) and the water bag (22). The flexible heating carpet (3) includes flexible flat electrical heating strips (31) that are connected to the electrical connection mechanism (32). The flexible heating carpet (3) is positioned in the dry space (7) between the flexible outer layer (21) and the water bag (22). By that, the flexible heating carpet that includes the flexible flat electrical heating strips (31) is positioned in a dry space and they have no contact with water. The electrical connection mechanism (32) is designed to connect the flexible flat electrical heating strips (31) to the photovoltaic solar panel (91) or to the wind turbine (92). The flexible heating carpet, due to its flexibility and the flexibility of the flexible flat electrical heating strips can receive the rounded shape of the flexible water heating tank (2) when filled by water or the flat shape when empty. The system (9) may include a controller (33) that may include thermometer for measuring the temperature of the water in the flexible water heating tank (2).

The outer layer (21) is preferably made of materials such as PVC, PE or other materials that are flexible enough to enable the tank (2) to inflate when it is filled with water and deflate when the water is drained out from it. The material must also be strong enough so that the outer layer does not tear under the weight of the water or upon contact or impact with other objects or with the ground when the system (9) is in use or is being transported to its required location. The separable inflatable and collapsible water bag (22) may be made of a food-safe material, i.e. a material approved by the relevant authorities for storing drinking water. The insulating layer (23) can be made of any known and existing insulating material. The flexible heating carpet (3) is designed to heat the water in the water bag (22) using flexible electrical heating strips (31) that may be attached to the water bag (22) in such a way that leads to high energy efficiency.

The electrical connection mechanism (32) may include an electronic card and an electrical circuit designed to connect the electrical strips (31) to the photovoltaic solar panel (91) or to the wind turbine (92).

It is possible and preferable to use two or more flexible water heating tanks (2) in a total volume as needed, instead of using one tank in the same volume. In such case, it is possible to provide the hot water to the consumer (95) from the first tank (2a), to stream into the first tank hot water from the second tank (2b), then to fill water from the main pipeline (96) into the second tank (2b) that become colder and to heat the water in the second tank (2b) by the photovoltaic solar panel (91) or the wind turbine (92). Until the water in the second tank warms to the desired temperature, it is possible to continue to supply hot water at the desired temperature from the first tank (closer to the consumer). As described above, the fact that the total volume of the tanks is 20 times larger than the volume of the average hourly hot water consumption of the specific consumer (95) enables such operation.

The system (9) offers many advantages: using renewable energy for supplying hot and cold water to consumers according needs regardless of the amount of electrical production in each given moment; the water heating tank (2) is lightweight and can be transported and set up in relevant location easily and safely, as opposed to rigid tanks; scale does not likely to accumulate on the flexible water heating tank (2) since the electrical heating strips do not come in direct contact with water and since there is no contact between the water and a metallic heating system the water are kept in drinking quality and may be used during shortage and crisis situation. If, nevertheless, scale accumulate on the water bag (22) it is possible to replace it easily and inexpensively.

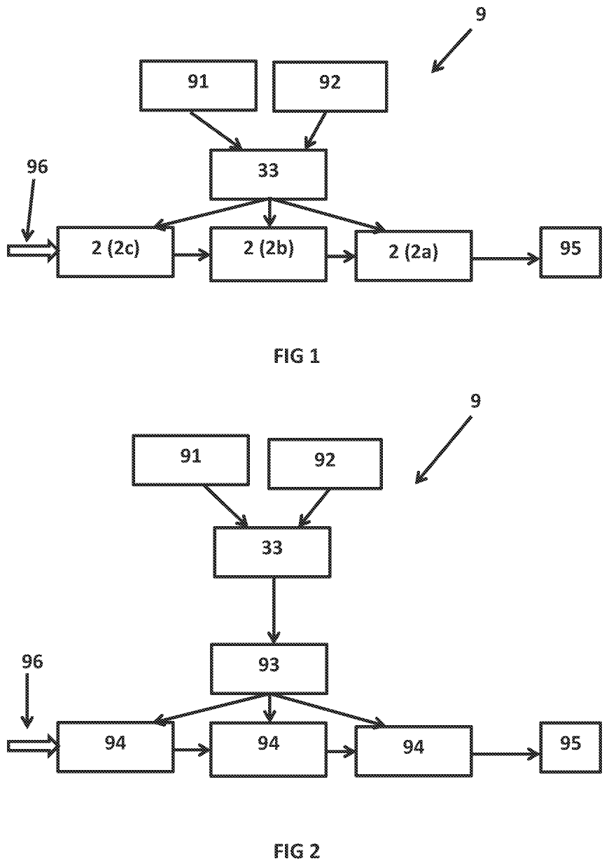

FIG. 1 presents schematically the system (9) for supplying hot water to consumer (95) that incudes photovoltaic solar panel (91), wind turbine (92), and several flexible water heating tanks (2). FIG. 2 presents schematically the system (9) for supplying cold water to consumer (95) that incudes photovoltaic solar panel (91), wind turbine (92), cooling system (93) and several flexible water tanks (94). As stated above the system (9) is designed also to provide cold water by employing cooling system (93) that can cool the water in the flexible water tanks (94), possible by circulation.

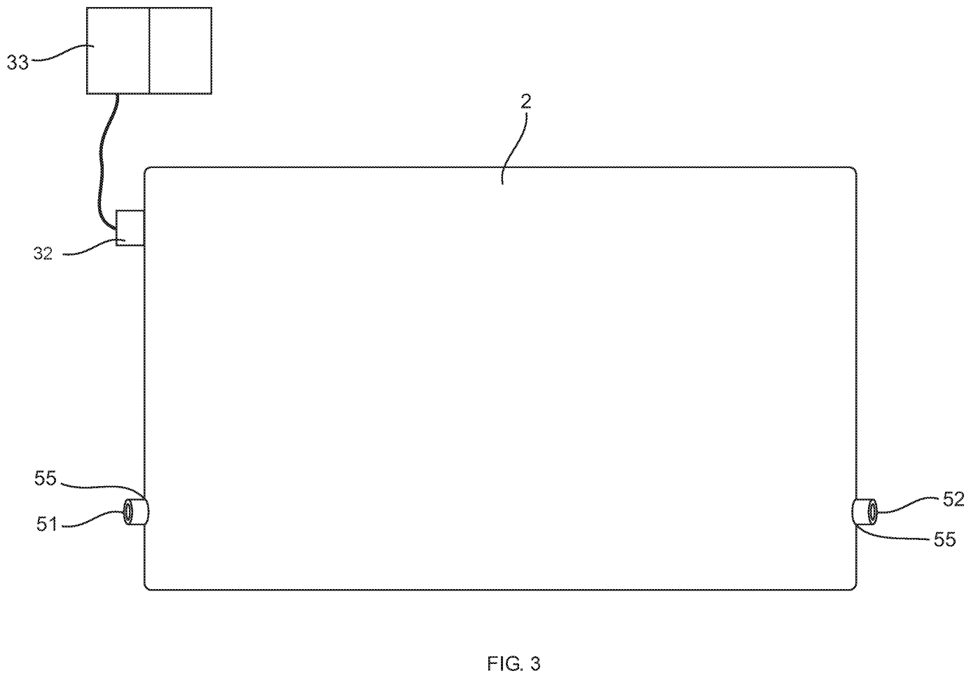

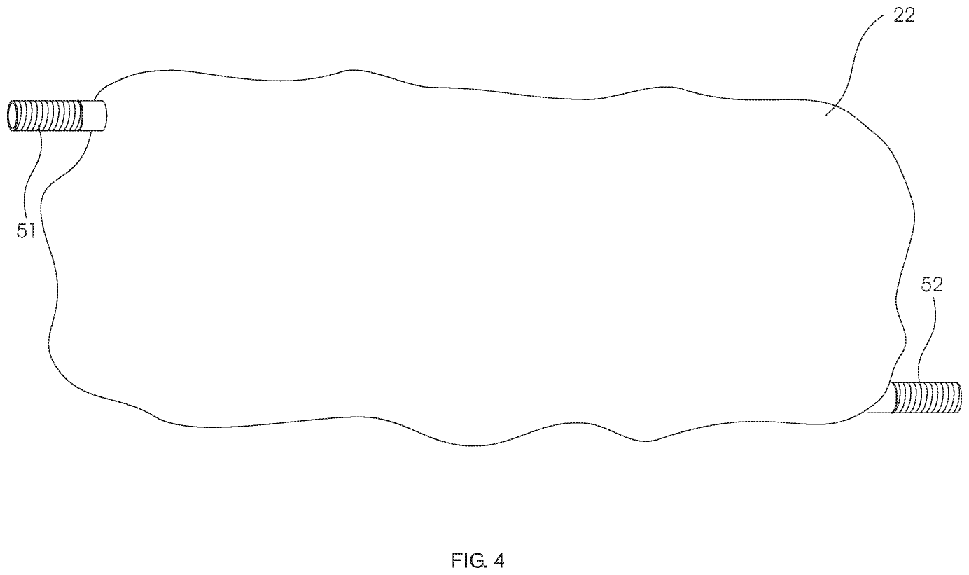

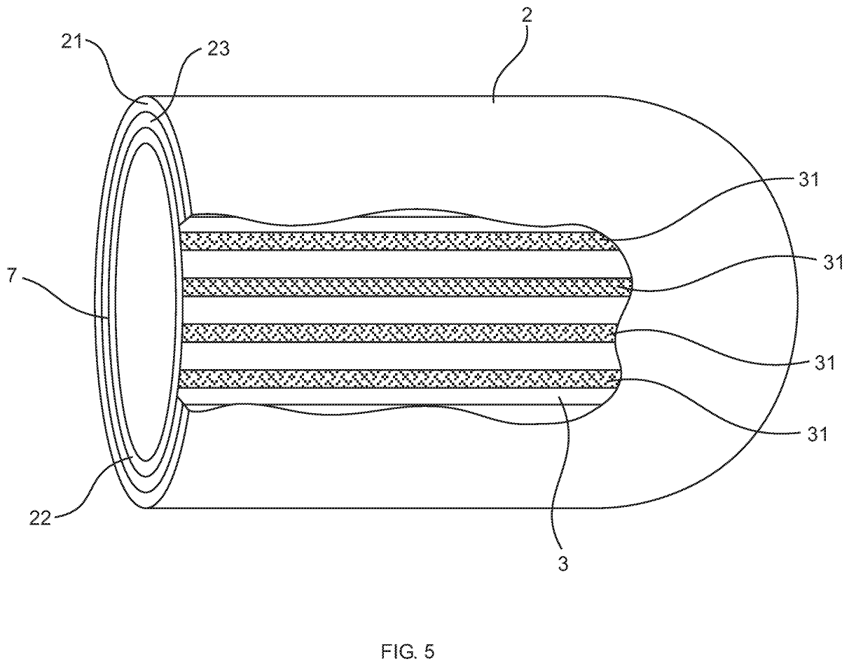

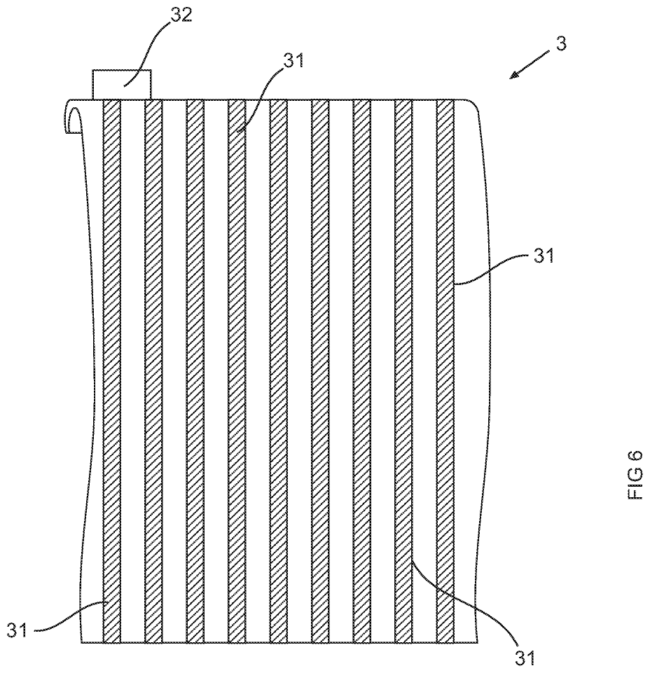

FIG. 3 presents schematically the flexible water heating tank (2), the water inlet hose (51), the water outlet hose (52), the electrical connection mechanism (32), and the controller (33). FIG. 4 presents schematically the water bag (22) and its water inlet hose (51). FIG. 5 presents schematically the flexible water heating tank (2) with the flexible heating carpet (3). FIG. 6 presents schematically the flexible heating carpet (3) with the flexible electrical heating strips (31).

It is understood that it is possible that the system (9) may include just one photovoltaic solar panel, or few; that the system (9) may include just one wind turbine, of few; and that the system (9) may include wind turbine and photovoltaic solar panel, of few of each.

We can summarize the method and the system (9) as follows:

First: A system for supplying hot water to a consumer, comprising: photovoltaic solar panel or wind turbine and flexible water heating tank;
wherein said flexible water heating tank comprises a flexible outer layer, a flexible heating carpet, a separable inflatable and collapsible water bag, and an electrical connection mechanism; wherein said separable inflatable and collapsible water bag is equipped with a water inlet hose and a water outlet hose; wherein said separable inflatable and collapsible water bag is designed to receive water through the water inlet hose and to supply water through the water outlet hose;
wherein said separable inflatable and collapsible water bag is positioned inside the flexible outer layer and is designed to remain collapsed when empty; wherein said water inlet hose and said water outlet hose are accessible through an opening in said flexible outer layer; wherein said separable inflatable and collapsible water bag can be replaced by a new one;
wherein said separable inflatable and collapsible water bag is designed to inflate when filled with water while positioned in said flexible outer layer and to deflate when the water is drained from said separable inflatable and collapsible water bag; wherein said flexible outer layer is designed to inflate when said separable inflatable and collapsible water bag is filled with the water while positioned in said flexible outer layer and to deflate when the water is drained from said separable inflatable and collapsible water bag;
wherein a dry space is defined between said flexible outer layer and said separable inflatable and collapsible water bag; wherein said flexible heating carpet includes flexible flat electrical heating strips that are connected to the electrical connection mechanism; wherein said flexible heating carpet is positioned in the dry space between the flexible outer layer and the separable inflatable and collapsible water bag; wherein said electrical connection mechanism is designed to connect the flexible flat electrical heating strips to the photovoltaic solar panel or to the wind turbine;
wherein the volume of the flexible water heating tank is larger than the volume of an average hourly hot water consumption of the consumer;
whereby enabling the production electricity by the photovoltaic solar panel at times of sunlight or by the wind turbine at times of wind;
whereby enabling usage of the electricity directly to heat the water inside the flexible water heating tank;
whereby enabling to supply the hot water to the consumer at times of need also at times that the photovoltaic solar panel and the wind turbine do not produce electricity.

Second: A system for supplying cold water to a consumer, comprising: photovoltaic solar panel or wind turbine, cooling system and flexible water tank;
wherein said flexible water tank comprises a flexible outer layer, a separable inflatable and collapsible water bag; wherein said separable inflatable and collapsible water bag is equipped with a water inlet hose and a water outlet hose; wherein said separable inflatable and collapsible water bag is designed to receive water through the water inlet hose and to supply water through the water outlet hose;
wherein said separable inflatable and collapsible water bag is positioned inside the flexible outer layer and is designed to remain collapsed when empty;
wherein said water inlet hose and said water outlet hose are accessible through an opening in said flexible outer layer; wherein said separable inflatable and collapsible water bag can be replaced by a new one;
wherein said separable inflatable and collapsible water bag is designed to inflate when filled with water while positioned in said flexible outer layer and to deflate when the water is drained from said separable inflatable and collapsible water bag; wherein said flexible outer layer is designed to inflate when said separable inflatable and collapsible water bag is filled with the water while positioned in said flexible outer layer and to deflate when the water is drained from said separable inflatable and collapsible water bag;
wherein said cooling system is designed to be electrically connected to the photovoltaic solar panel or to the wind turbine;
wherein the volume of the flexible water tank is larger than the volume of an average hourly cold water consumption of the consumer;
whereby enabling the production of electricity by the photovoltaic solar panel at times of sunlight or by the wind turbine at times of wind;
whereby enabling the usage of the electricity directly to cool water and to stream the cold water into the flexible water tank;
whereby enabling to supply the cold water to the consumer at times of need also at times that the photovoltaic solar panel and the wind turbine do not produce electricity.

Third: A method for supplying hot water to a consumer, comprising:
(a) providing photovoltaic solar panel or wind turbine;
(b) providing flexible water heating tank; wherein said flexible water heating tank comprises a flexible outer layer, a flexible heating carpet, a separable inflatable and collapsible water bag, and an electrical connection mechanism; wherein said separable inflatable and collapsible water bag is equipped with a water inlet hose and a water outlet hose; wherein said separable inflatable and collapsible water bag is designed to receive water through the water inlet hose and to supply water through the water outlet hose; wherein said separable inflatable and collapsible water bag is positioned inside the flexible outer layer and is designed to remain collapsed when empty; wherein said water inlet hose and said water outlet hose are accessible through an opening in said flexible outer layer; wherein said separable inflatable and collapsible water bag can be replaced by a new one; wherein said separable inflatable and collapsible water bag is designed to inflate when filled with water while positioned in said flexible outer layer and to deflate when the water is drained from said separable inflatable and collapsible water bag; wherein said flexible outer layer is designed to inflate when said separable inflatable and collapsible water bag is filled with the water while positioned in said flexible outer layer and to deflate when the water is drained from said separable inflatable and collapsible water bag; wherein a dry space is defined between said flexible outer layer and said separable inflatable and collapsible water bag; wherein said flexible heating carpet includes flexible flat electrical heating strips that are connected to the electrical connection mechanism; wherein said flexible heating carpet is positioned in the dry space between the flexible outer layer and the separable inflatable and collapsible water bag; wherein said electrical connection mechanism is designed to connect the flexible flat electrical heating strips to the photovoltaic solar panel or to the wind turbine;
(c) wherein the volume of the flexible water heating tank is larger than the volume of an average hourly hot water consumption of the consumer;
(d) whereby enabling the production of electricity by the photovoltaic solar panel at times of sunlight or by the wind turbine at times of wind;
(e) whereby using the electricity directly to heat the water inside the flexible water heating tank; and
(f) whereby enabling to supply the hot water to the consumer at times of need also at times that the photovoltaic solar panel and the wind turbine do not produce electricity.

Fourth: A method for supplying cold water to a consumer, comprising:
(a) providing photovoltaic solar panel or wind turbine;
(b) providing a cooling system;
(c) providing a flexible water tank; wherein said flexible water tank comprises a flexible outer layer, a separable inflatable and collapsible water bag; wherein said separable inflatable and collapsible water bag is equipped with a water inlet hose and a water outlet hose; wherein said separable inflatable and collapsible water bag is designed to receive water through the water inlet hose and to supply water through the water outlet hose; wherein said separable inflatable and collapsible water bag is positioned inside the flexible outer layer and is designed to remain collapsed when empty; wherein said water inlet hose and said water outlet hose are accessible through an opening in said flexible outer layer; wherein said separable inflatable and collapsible water bag can be replaced by a new one; wherein said separable inflatable and collapsible water bag is designed to inflate when filled with water while positioned in said flexible outer layer and to deflate when the water is drained from said separable inflatable and collapsible water bag; wherein said flexible outer layer is designed to inflate when said separable inflatable and collapsible water bag is filled with the water while positioned in said flexible outer layer and to deflate when the water is drained from said separable inflatable and collapsible water bag; wherein said cooling system is designed to be electrically connected to the photovoltaic solar panel or to the wind turbine;
(d) wherein the volume of the flexible water tank is larger than the volume of an average hourly cold water consumption of the consumer;
(e) whereby enabling the production of electricity by the photovoltaic solar panel at times of sunlight or by the wind turbine at times of wind;
(f) whereby enabling the usage of the electricity directly to cool water and to stream the cold water into the flexible water tank;
(g) whereby enabling to supply the cold water to the consumer at times of need also at times that the photovoltaic solar panel and the wind turbine do not produce electricity.

What is claimed is:

1. A system for supplying hot water to a consumer, comprising: photovoltaic solar panel or wind turbine and flexible water heating tank;
wherein said flexible water heating tank comprises a flexible outer layer, a flexible heating carpet, a separable inflatable and collapsible water bag, and an electrical connection mechanism; wherein said separable inflatable and collapsible water bag is equipped with a water inlet hose and a water outlet hose; wherein said separable inflatable and collapsible water bag is designed to receive water through the water inlet hose and to supply water through the water outlet hose;
wherein said separable inflatable and collapsible water bag is positioned inside the flexible outer layer and is designed to remain collapsed when empty; wherein said water inlet hose and said water outlet hose are accessible through an opening in said flexible outer layer; wherein said separable inflatable and collapsible water bag can be replaced by a new one;
wherein said separable inflatable and collapsible water bag is designed to inflate when filled with water while positioned in said flexible outer layer and to deflate when the water is drained from said separable inflatable and collapsible water bag; wherein said flexible outer layer is designed to inflate when said separable inflatable and collapsible water bag is filled with the water while positioned in said flexible outer layer and to deflate when the water is drained from said separable inflatable and collapsible water bag;
wherein a dry space is defined between said flexible outer layer and said separable inflatable and collapsible water bag; wherein said flexible heating carpet includes flexible flat electrical heating strips that are connected to the electrical connection mechanism; wherein said flexible heating carpet is positioned in the dry space between the flexible outer layer and the separable inflatable and collapsible water bag; wherein said electrical connection mechanism is designed to connect the flexible flat electrical heating strips to the photovoltaic solar panel or to the wind turbine;
wherein the volume of the flexible water heating tank is larger than the volume of an average hourly hot water consumption of the consumer;
whereby enabling the production electricity by the photovoltaic solar panel at times of sunlight or by the wind turbine at times of wind;
whereby enabling usage of the electricity directly to heat the water inside the flexible water heating tank;
whereby enabling to supply the hot water to the consumer at times of need also at times that the photovoltaic solar panel and the wind turbine do not produce electricity.

2. A system for supplying cold water to a consumer, comprising: photovoltaic solar panel or wind turbine, cooling system and flexible water tank;
wherein said flexible water tank comprises a flexible outer layer, a separable inflatable and collapsible water bag; wherein said separable inflatable and collapsible water bag is equipped with a water inlet hose and a water outlet hose; wherein said separable inflatable and collapsible water bag is designed to receive water through the water inlet hose and to supply water through the water outlet hose;
wherein said separable inflatable and collapsible water bag is positioned inside the flexible outer layer and is designed to remain collapsed when empty; wherein said water inlet hose and said water outlet hose are accessible through an opening in said flexible outer layer; wherein said separable inflatable and collapsible water bag can be replaced by a new one;
wherein said separable inflatable and collapsible water bag is designed to inflate when filled with water while positioned in said flexible outer layer and to deflate when the water is drained from said separable inflatable and collapsible water bag; wherein said flexible outer layer is designed to inflate when said separable inflatable and collapsible water bag is filled with the water while positioned in said flexible outer layer and to deflate when the water is drained from said separable inflatable and collapsible water bag;
wherein said cooling system is designed to be electrically connected to the photovoltaic solar panel or to the wind turbine;
wherein the volume of the flexible water tank is larger than the volume of an average hourly cold water consumption of the consumer;
whereby enabling the production of electricity by the photovoltaic solar panel at times of sunlight or by the wind turbine at times of wind;
whereby enabling the usage of the electricity directly to cool water and to stream the cold water into the flexible water tank;
whereby enabling to supply the cold water to the consumer at times of need also at times that the photovoltaic solar panel and the wind turbine do not produce electricity.

3. A method for supplying hot water to a consumer, comprising:
(a) providing photovoltaic solar panel or wind turbine;
(b) providing flexible water heating tank; wherein said flexible water heating tank comprises a flexible outer layer, a flexible heating carpet, a separable inflatable and collapsible water bag, and an electrical connection mechanism; wherein said separable inflatable and collapsible water bag is equipped with a water inlet hose and a water outlet hose; wherein said separable inflatable and collapsible water bag is designed to receive water through the water inlet hose and to supply water through the water outlet hose; wherein said separable inflatable and collapsible water bag is positioned inside the flexible outer layer and is designed to remain collapsed when empty; wherein said water inlet hose and said water outlet hose are accessible through an opening in said flexible outer layer; wherein said separable inflatable and collapsible water bag can be replaced by a new one; wherein said separable inflatable and collapsible water bag is designed to inflate when filled with water while positioned in said flexible outer layer and to deflate when the water is drained from said separable inflatable and collapsible water bag; wherein said flexible outer layer is designed to inflate when said separable inflatable and collapsible water bag is filled with the water while positioned in said flexible outer layer and to deflate when the water is drained from said separable inflatable and collapsible water bag; wherein a dry space is defined between said flexible outer layer and said separable inflatable and collapsible water bag; wherein said flexible heating carpet includes flexible flat electrical heating strips that are connected to the electrical connection mechanism; wherein said flexible heating carpet is positioned in the dry space between the flexible outer layer and the separable inflatable and collapsible water bag; wherein said electrical connection mechanism is designed to connect the flexible flat electrical heating strips to the photovoltaic solar panel or to the wind turbine;
(c) wherein the volume of the flexible water heating tank is larger than the volume of an average hourly hot water consumption of the consumer;
(d) whereby enabling the production of electricity by the photovoltaic solar panel at times of sunlight or by the wind turbine at times of wind;
(e) whereby using the electricity directly to heat the water inside the flexible water heating tank; and
(f) whereby enabling to supply the hot water to the consumer at times of need also at times that the photovoltaic solar panel and the wind turbine do not produce electricity.

4. A method for supplying cold water to a consumer, comprising:
(a) providing photovoltaic solar panel or wind turbine;
(b) providing a cooling system;
(c) providing a flexible water tank; wherein said flexible water tank comprises a flexible outer layer, a separable inflatable and collapsible water bag; wherein said separable inflatable and collapsible water bag is equipped with a water inlet hose and a water outlet hose; wherein said separable inflatable and collapsible water bag is designed to receive water through the water inlet hose and to supply water through the water outlet hose; wherein said separable inflatable and collapsible water bag is positioned inside the flexible outer layer and is designed to remain collapsed when empty; wherein said water inlet hose and said water outlet hose are accessible through an opening in said flexible outer layer; wherein said separable inflatable and collapsible water bag can be replaced by a new one; wherein said separable inflatable and collapsible water bag is designed to inflate when filled with water while positioned in said flexible outer layer and to deflate when the water is drained from said separable inflatable and collapsible water bag; wherein said flexible outer layer is designed to inflate when said separable inflatable and collapsible water bag is filled with the water while positioned in said flexible outer layer and to deflate when the water is drained from said separable inflatable and collapsible water bag; wherein said cooling system is designed to be electrically connected to the photovoltaic solar panel or to the wind turbine;
(d) wherein the volume of the flexible water tank is larger than the volume of an average hourly cold water consumption of the consumer;
(e) whereby enabling the production of electricity by the photovoltaic solar panel at times of sunlight or by the wind turbine at times of wind;
(f) whereby enabling the usage of the electricity directly to cool water and to stream the cold water into the flexible water tank;
(g) whereby enabling to supply the cold water to the consumer at times of need also at times that the photovoltaic solar panel and the wind turbine do not produce electricity.
